(19) United States
(12) Patent Application Publication
(10) Pub. No.: US 2004/0244059 A1
(43) Pub. Date: Dec. 2, 2004

(54) Digital set-top box transmodulator

(75) Inventor: Ion Coman, San Jose, CA (US)

Correspondence Address: LSI LOGIC CORPORATION, 1621 BARBER LANE, MS: D-106 LEGAL, MILPITAS, CA, 95035, US

(73) Assignee: LSI LOGIC CORPORATION

(21) Appl. No.: 10/448,752

(22) Filed: May 30, 2003

(51) Int. Cl. H04N 7/173; H04N 7/20; H04N 7/16; H04N 5/50

(52) U.S. Cl. 725/139; 725/131; 725/68; 348/731

(57) ABSTRACT

An apparatus comprising a set-top box and a conversion circuit. The set-top box may be configured to generate output signals in response to a first encoded data signal. The conversion circuit may be configured to present the first encoded data signal in response to a second encoded data signal received from an external source. The first encoded data signal comprises a legacy signal and the second encoded data signal comprises an advanced data signal.

### FIELD OF THE INVENTION

The present invention relates to modulators generally and, more particularly, to a transmodulator for digital set-top boxes that may be implemented in applications such as digital television transmission (e.g., satellite, cable and terrestrial transmissions).

### BACKGROUND OF THE INVENTION

Convention set top boxes already deployed in the filed comply with some type modulation and error correction standards. As new modulation and coding schemes are being introduced, backward compatibility in the transmitted signal cannot be preserved at all times. Incompatibility often forces service operators to swap out large numbers of set-top-boxes in order to allow the users to receive the new signal format. Such swap outs are costly and undesirable.

Some conventional approaches to set top box compatibility implement backwards-compatible modulation, such as hierarchical modulation. One such approach has been proposed by DirecTV as DVB-S2 for a satellite STB. However, backwards compatibility is only a partial solution to the problem and can have additional drawbacks. In particular, the DirecTV proposal provides sub-optimal data transmission since some loss is introduced. The additional loss has resulted in other operators avoiding the implementation of the proposal.

It would be desirable to implement a transmodulator that may be installed in the signal path before a set-top box to convert an advanced data signal to a legacy data signal for set-top boxes that are not compliant with the advanced data signal.

### SUMMARY OF THE INVENTION

The present invention concerns an apparatus comprising a set-top box and a conversion circuit. The set-top box may be configured to generate output signals in response to a first encoded data signal. The conversion circuit may be configured to present the first encoded data signal in response to a second encoded data signal generally received from an external source. The first encoded data signal generally comprises a legacy signal and the second encoded data signal comprises an advanced data signal.

The objects, features and advantages of the present invention include providing a digital set-top box transmodulator that may (i) implement MPEG null packet loading for read back; (ii) implement controlled transmitter power based on receiver power estimation; (iii) implement a single PLL in a zero IF transceiver; (iv) lower the cost of implementation; (v) allow rapid download of a register map to the set-top box; (vi) provide improved intermodulation performance when transmit and receive are integrated in small, low cost integrated circuit (IC) packages; and/or (vii) implement a loop through bypass to support operation in a legacy mode.

### BRIEF DESCRIPTION OF THE DRAWINGS

These and other objects, features and advantages of the present invention will be apparent from the following detailed description and the appended claims and drawings in which:

FIG. 1 is a block diagram of a satellite system in accordance with a preferred embodiment of the present invention;

FIG. 2 is a more detailed diagram of one embodiment of the system of FIG. 1;

FIG. 3 is a more detailed diagram of another embodiment of the system of FIG. 1;

FIG. 4 is a more detailed diagram of the processing section of FIG. 2 illustrating an I/Q implementation output; and

FIG. 5 is a diagram illustrating an alternate implementation of a portion of the circuit of FIG. 3.

### DETAILED DESCRIPTION OF THE PREFERRED EMBODIMENTS

The present invention may enable legacy receivers (or set-top boxes) already deployed in the field to operate with advanced modulation/FEC signals (e.g., 8PSK and Turbo Coded signal, a Low Density Parity Check (LDPC), etc.) when the receiver is not compliant with the advanced signal. The present invention may be implemented between an incoming signal (e.g., a satellite signal) and a set top box to convert new data streams to a format usable by existing boxes. The present invention may provide one or more of the following (i) provide a conversion from one format (e.g., 8PSK/16QAM+TC signals or LDPC signals) to another format (e.g., QPSK DVB-S signals), (ii) implement a radio frequency (RF) Loop Through bypass of the module for operation in one implementation of a legacy mode, and (iii) pass LNB supply current from a STB to a dish antenna. The legacy mode may provide low power consumption since the transmodulator can be put on standby or sleep. Another option for the legacy mode may be to have the transmodulator configured for a transparent mode (e.g., demodulation and modulation of the same data format). The present invention may also (i) be implemented at a low cost, (ii) be implemented with a small form factor, (iii) provide easy installation, (iv) have low power consumption, (v) support DVB-S2 to DVB-S conversion and/or (vi) be implemented as a single integrated circuit.

The main functions of the transmodulator of the present invention may be implemented by using existing technology. However, functions such as MPEG null packet loading are not available with standard products used in the set top box (STB) industry. The transmodulator may be implemented anywhere in the signal chain before the set-top box. For example, the transmodulator may be implemented indoors in the vicinity of the STB. In another example, the transmodulator may be implemented outdoors in the vicinity of the receiving dish antenna.

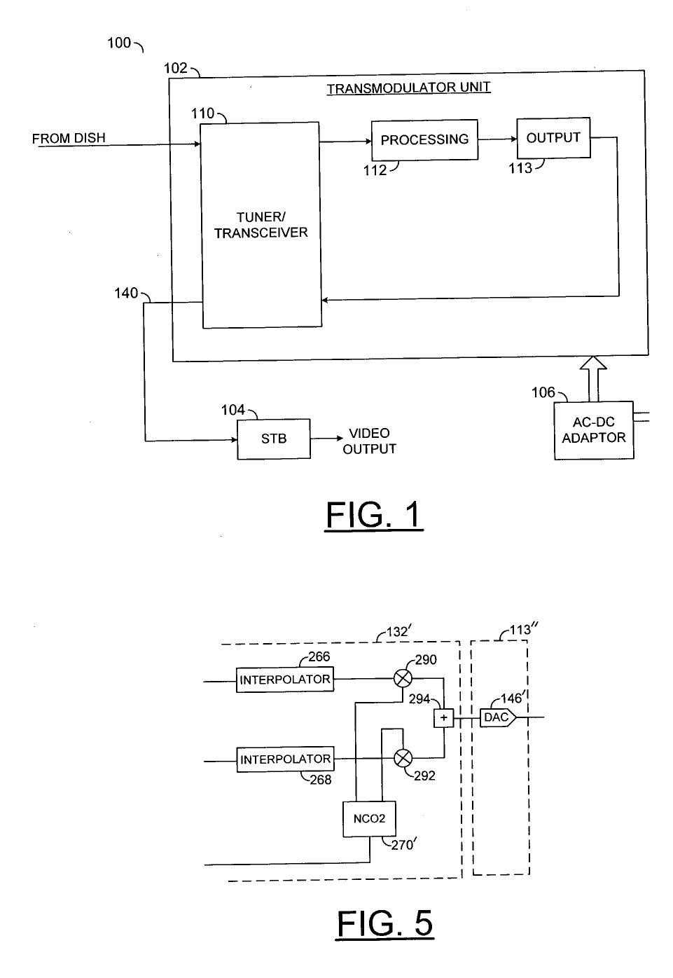

Referring to FIG. 1, a diagram of a system 100 is shown. The system 100 generally comprises a conversion block (or circuit) 102 and a set-top box (STB) 104. A power supply 106 may present power to the circuit 102. The conversion circuit 102 may receive an encoded signal (e.g., FROM_DISH). The STB 104 may generate a signal (e.g., VIDEO OUTPUT). The signal VIDEO OUTPUT may be a video signal that may be presented on a monitor. The signal VIDEO_OUTPUT may be presented in one or more video formats (e.g., composite, S-video, component, RGB, etc.). In a minimal cost environment, a composite signal may be preferred. In one example, the power supply 106 may be implemented as an AC-DC adaptor. However, other power sources may be implemented to meet the design criteria of a particular implementation. In another example, a power supply may be received from the 13 v/18 v the low noise block (LNB) of a dish. The transmodulator unit 102 may be implemented using a single integrated circuit or number of integrated circuits that operate from the same external power supply 106 or from power received from the set-top box 104. Regardless of the level of integration and partitioning the following functions are implemented (i) a receiver/tuner and (ii) a transmitter/modulator. The receiver/tuner and the transmitter may be implemented as a single integrated circuit or a number of integrated circuits.

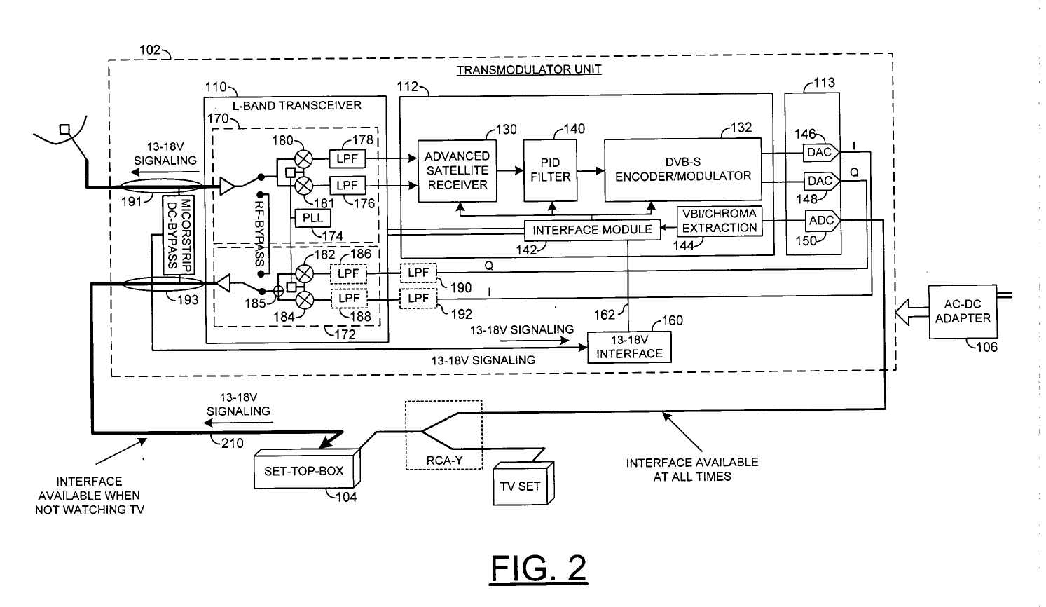

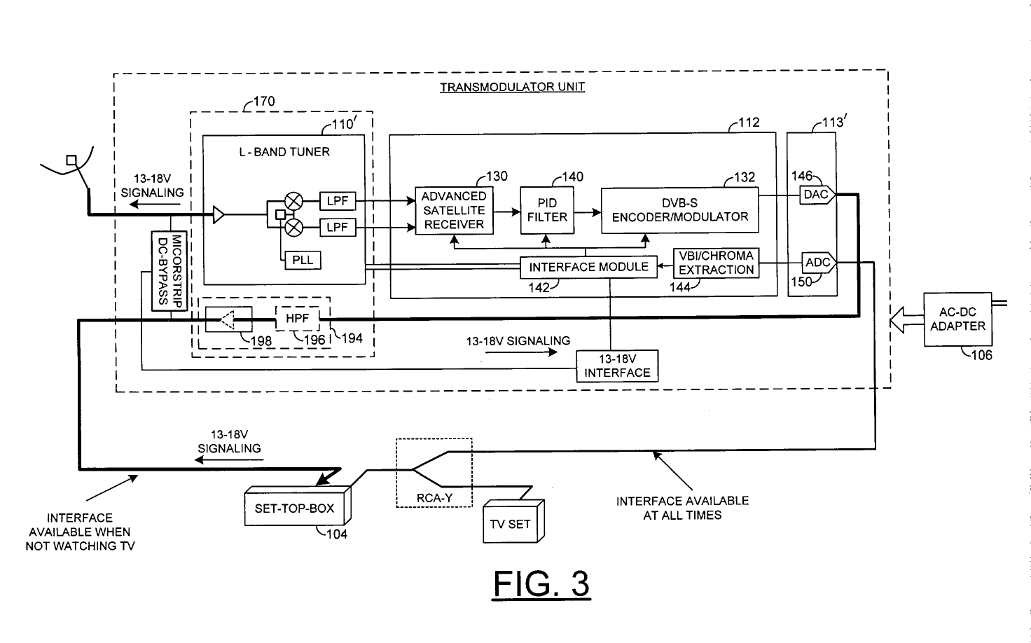

The transmodulator 102 generally comprise an input section (or circuit) 110, a demodulation/modulation (or processing) section (or circuit) 112 and an output section (or circuit) 113. The input section 110 may be implemented as a radio frequency (RF) transceiver (to be described in detail in connection with FIG. 2) or a tuner (to be described in detail in connection with FIG. 3). The processing circuit 112 may be implemented as a transmodulator circuit. The output circuit 113 may be connected to the STB 104 directly, or through the input section 110.

Communication between the STB 104 and the transmodulator unit 102 may be implemented through a feeder (e.g., a coaxial cable) 140. The cable 140 may allow programming of the transmodulator unit 102. Such communication may also be used to read back information needed by a CPU (not shown) in the STB 104. The communication protocol used would normally be compatible with existing signaling since the transmodulator unit 102 is generally designed to operate with legacy receivers. In a satellite implementation, the use of 22 kHz tone (sometimes referred to as a DiSEqC compliant tone) is generally possible. The 22 kHz tone is normally available between the STB 104 and the low noise block (LNB) of the dish antenna. Other ways of programming the transmodulator unit 102 may be implemented such as using vertical blanking interval (VBI) slots in the video signal from the signal VIDEO OUTPUT of STB 104. In such an implementation, the signal VIDEO OUTPUT would be looped through the transmodulator unit 102. While the communication based on the signal VIDEO OUTPUT may be slow, such an implementation may be useful in applications where the STB 104 needs to write to the circuit 102 while providing service. For example, basing communication on the signal VIDEO OUTPUT may avoid possible interference that the 22 KHz tone may cause. Such an implementation may also be useful when a read back is done via null packets. While the present invention may be implemented as a discrete device, an integrated solution may reduce cost, size and/or power.

Referring to FIGS. 2 and 3, more detailed diagrams of the transmodulator circuit 102 are shown. In FIG. 2, the circuit 110 is shown implemented as a transceiver. The processing section 112 generally comprises a block (or circuit) 130, a block (or circuit) 132, a filter section (or circuit) 140, an interface module (or circuit) 142, extraction circuit 144. The output section 113 generally comprises a conversion circuit 146, a conversion circuit 148, and a conversion circuit 150. The extraction circuit 114 may be implemented as a VBI extraction circuit. The conversion circuits 146 and 148 may be implemented as digital to analog (D/A) conversion circuits. The conversion circuit 150 may be implemented as an analog to digital (A/D) conversion circuit. A control interface 160 may communicate with the interface module 142 over a control line 162. The control interface 160 may be implemented using the DC (13-18V) supply modulated with the 22 kHz tone from the LNB. The circuit 144 may be implemented as a VBI/Chroma extraction circuit. The circuit 144 may be used to decode closed captioning (CC) using VBI slots or Chroma on BB video output with messages needed to program the transmodulator unit 102 during power up of the STB 104.

The circuit 110 is shown implemented as a transceiver. In one example, the transceiver 110 may be implemented as an L-band transceiver. The transceiver 110 generally comprises a receiver (or tuner) block (or circuit) 170 and a transmit block (or circuit) 172. The tuner 170 generally comprises a phase locked loop (PLL) 174, a filter block (or circuit) 176, a filter block (or circuit) 178, a mixer block (or circuit) 180 and a mixer block (or circuit) 181. A node (e.g., RF_BYPASS) may be connected between the tuner 170 and the transmit block 172. The transmit block 172 generally comprises a mixer block (or circuit) 182, a mixer block (or circuit) 184, a filter block (or circuit) 186, a filter block (or circuit) 188 and a summing block (or circuit) 185. A filter block (or circuit) 190 may be coupled between the output of the DAC 148 and the filter 186. A filter block (or circuit) 192 may be coupled between the output of the DAC 146 and the filter 188. The filters 176, 178, 186, 188, 190 and 192 may be implemented as low pass filters.

The circuit 140 may provide program filtering by implementing a PID filter. The circuit 140 may be controlled through a control interface. The output circuit 113 may present quadrature signals (e.g., I and Q) from the DACS 146 and 148 for a Zero-IF RF Modulation implementation. A direct RF from V-DAC (harmonic) may be implemented.

In FIG. 3, the output section 113′ is shown implementing a single DAC 146. In such implementation, the circuit 110′ may be implemented as the tuner 170 and a filter section (or circuit) 194. The filter section 194 may be implemented as a high pass filter 196 and an amplifier (or buffer) 198. The sampling frequency in FIG. 3 may need to be much higher to allow IF sampling. The circuit 110′ is shown implemented as a tuner.

In both FIGS. 2 and 3, the signal from the output section 113 (or 113′) is generally available to the STB 104 at all times. An interface 210 (e.g., from the input section 110 or 110′) may only be available when the STB 104 is not used for watching a program.

The processing section 112 may be implemented as a transmodulator integrated circuit. The receiver 130 may be implemented as a satellite receiver. The processing section 112 may be used to reduce throughput needed for 20 MSps transmission to the STB 104. The processing section 112 generally presents a direct IF (e.g., as in FIG. 3) or I and Q (e.g., as in FIG. 2) via the DACs 146 and 148 (typically 6-8 bit converter for I/Q and approximately 10-bits for an IF output). Communication is generally maintained with the STB 104 via VBI signaling and MPEG layer or via the 22 KHz modulation on the LNB supply. The power consumption of the output circuit 112 may be in the range of 0.5-1.5 W.

In the case of a satellite STB 104, the tuner 120 may be implemented with zero-IF (e.g., direct conversion) that may allow sharing of the PLL 174 with the Tx modulator 172. Such an implementation may provide improved performance in terms of interference. The transmitter modulator 172 may be implemented with a zero-IF architecture (for satellite applications) in order to use the PLL 174 from the input section 170. Such an approach has a number of advantages. For example, an incoming channel and a transmitted channel may be implemented using the same frequency. By using the same frequency, a reduction of the possible interference that can appear due to second and third order products with channels sitting at other frequencies is generally achieved.

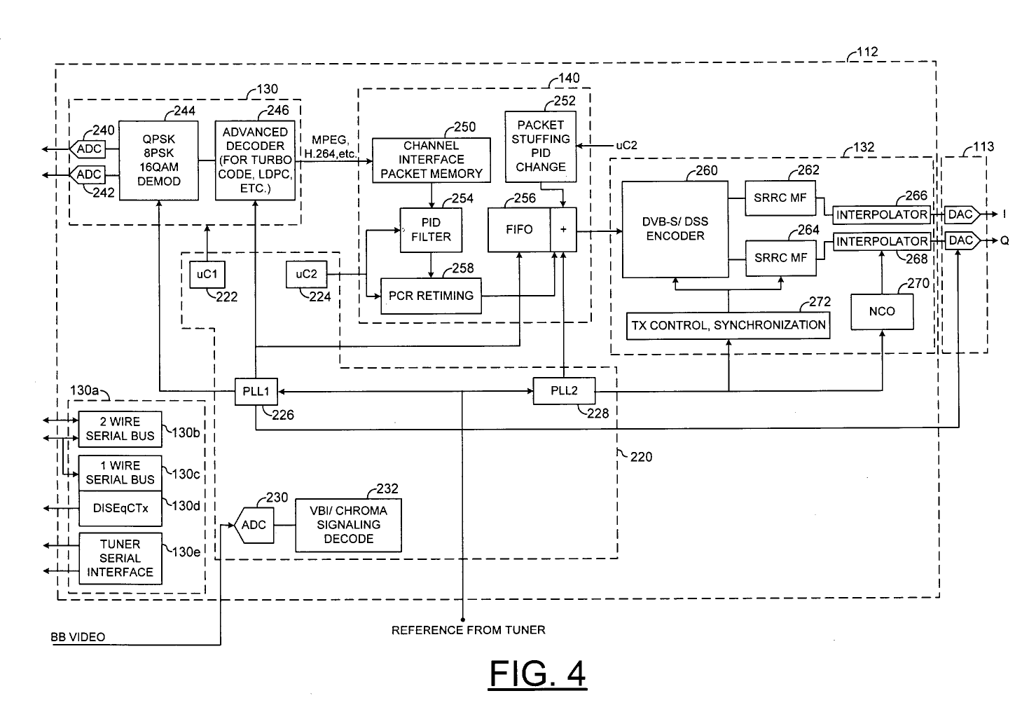

Referring to FIG. 4, a more detailed diagram of the transmodulator 112 is shown. The transmodulator 112 maintains functionality for standalone receiver applications. The transmodulator 112 generally reduces throughput for a 20 MSps transmission to the STB 104 for legacy box compatibility. The transmodulator 102 presents either direct RF (e.g., as in FIG. 3) or I and Q (as in FIG. 2) via an n-bit (e.g., 4-6 bit) DAC (or sigma-delta modulator). Communication may be established with the STB via VBI signaling and MPEG layer or coax cable (13-18 v) DC modulated with 22 KHz. The power consumption of the circuit of FIG. 4 is generally in the range of 0.5-1.5 W. While FIG. 4 illustrates the output circuit 113 of FIG. 2, the output circuit 113′ of FIG. 3 may be implemented to meet the design criteria of a particular implementation.

FIG. 4 also illustrates an additional auxiliary section (or circuit) 130a and a global control block (or circuit) 220. The circuit 130a generally comprises a bus interface 130b, a bus interface 130c, a transmit (Tx) circuit 130d and an interface 130e. The bus 130b may be implemented as a 2 wire serial bus. The bus 130c may be implemented as a one wire serial bus. The transmit circuit 130d may be DiSeQc compliant. The interface 130e may be implemented as a tuner/serial interface.

The circuit 220 generally comprises a block (or circuit) 222, a block (or circuit) 224, a block (or circuit) 226, a block (or circuit) 228, a block (or circuit) 230 and a block (or circuit) 232. The circuit 222 may be implemented as a microprocessor (or microcontroller). Similarly, the circuit 224 may also be implemented as a microprocessor (or microcontroller). The circuit 226 may be implemented as a PLL circuit. The circuit 228 may also be implemented as a PLL.

Details of the circuit 130, the circuit 132 and the circuit 140 are also shown. In particular, the circuit 130 generally comprises a conversion circuit 240, a conversion circuit 242, a demodulation circuit 244 and a decoder circuit 246. The conversion circuits 240 and 242 may be implemented as analog to digital converter circuits. The circuit 244 may be implemented as a QPSK/8PSK/16QAM demodulator. The circuit 246 may be implemented as a DVB-S2 or Echostar Turbo Code Decoder. However, other implementations may be used to meet the design criteria of a particular implementation. The circuit 130 may present an MPEG compatible bitstream to the circuit 140.

The circuit 140 generally comprises a circuit 250, a circuit 252, a circuit 254, a circuit 256 and a circuit 258. The circuit 250 generally comprises a channel interface packet memory circuit. The circuit 254 generally comprises a packet stuffing PID change circuit. The circuit 254 generally comprises a PID filter circuit. The circuit 256 generally comprises a first-in first-out (FIFO) buffer. The circuit 258 generally comprises a PCR retiming circuit. The circuit 250 may be connected to the circuit 254. The circuit 252, the circuit 254, and the circuit 258 generally present signals to the circuit 256. The circuits 254 and 258 generally receives information from the circuit 224. The PLL circuit 226 may provide a clock signal to the circuit 256. The circuit 256 is generally coupled to the circuit 132.

The circuit 132 generally comprises a circuit 260, a circuit 262, a circuit 264, a circuit 266, a circuit 268, a circuit 270, and a circuit 272. The circuit 260 generally comprises a DVD-S/DSS (legacy) encoder. The circuit 262 generally comprises a square root raised cosine/matched filter (SRRC/MF) circuit. Similarly, the circuit 264 generally comprises a SRRC/MF circuit. The circuit 266 may be implemented as an interpolator circuit. Similarly, the circuit 268 may be implemented as an interpolator circuit. The circuit 270 may be implemented as a numerically controlled oscillator (NCO) circuit. The circuit 272 may be implemented as a transmit control and synchronization circuit. The interpolator 266 and the interpolator 268 present signals to the output circuit 113.

Referring to FIG. 5, an alternate implementation of the circuit 132′ and the output circuit 113″ is shown. The circuit 132′ generally comprises a summing circuit 290, a summing circuit 292 and an adder circuit 294. The numerically controlled oscillator circuit 270′ may present a signal to each of the summing circuits 290 and 292. The signals presented by the circuits 290 and 292 are generally in quadrature with each other (e.g., out of phase by 90° or a sine and cosine). An output of each of the summing circuits 290 and 292 are generally added together by the adder circuit 294 and presented to the signal DAC 146′. The circuit 132′ may be implemented in the circuit described in connection with FIG. 3 (e.g., the implementation of a signal DAC 146′.

The system 100 may allow fast read back. For example, the demodulated signal is generally decoded to MPEG frames and made ready for re-encoding/re-modulation in the legacy format. Prior to encoding, the null packets in the stream are detected and loaded with the register map of the whole module. The PID of the packet has to be changed in order to make the packet recognizable at the output of the STB 104.

The system 100 may use integrated Zero IF receiver with a Zero IF transmitter. The system 100 may implement a single PLL when an output channel is at same frequency or at a harmonic (e.g., x2, x3, x4, etc.) frequency as an input channel. One or more transmit channels (e.g., Tx) may have Gain Control for matching the input channel power (to lower input/output crosstalk).

The circuit 100 may present a number of RF Issues that may be resolved. For example, crosstalk may arise from a signal RF_IN on an interface 191 to a signal RF_OUT on an interface 193. One approach to reduce distortion is to implement the Zero-IF Tx on the same channel and at the same frequency as the input channel. Such an implementation can share the same VCO and does not generate in-band high order products with incoming signals. A transmit automatic gain control (AGC) may be implemented to track incoming desired channel and maintain a desired power difference in between the received and the transmitted channels. The transmit signals Tx on the interface 193 may be transmitted at lower power to avoid crosstalk to the signal RF_INPUT. The transmit signals Tx may tolerate a certain amount of distortion since no other significant source of noise is present when the channel between the circuit 202 and STB 204 is implemented with a short connection. The minimum acceptable power level for the STB (e.g., in the range of −65 dBm) at RF_OUT may be acceptable at all times.

As mentioned above, a special feature is proposed for reducing the interference from the input signals Rx to the output signals Tx. The power level of the output signals Tx may be adjusted from the new demodulator power detector 130 after a matched filter. This generally allows the transmitted channel to track the received one in power maintaining a constant preset value if needed providing superior crosstalk preform.

The present invention may be used to implement RF IC Cost reduction is shown. Most of the interference issues are minimized if RF DAC is used. An RF IC using a 3.0V SiGe BiCMOS process may be implemented. The transmit power may be approximately 0.1 W. The receiver power may be approximately 0.4 W. The transmodulator IC may be implemented using a 0.13u process. The power consumption of the transmodulator unit may be (0.5-0.8 W). The modulator may consume in the range of ˜0.2 W. The total power consumed may be in the range of ˜1.5 W.

The present invention has been described in the context of an interface box. However, the present invention may be implemented anywhere in the data path before a legacy STB. For example, the present invention may be implemented in an expansion slot of the STB. In another example, the present invention may be implemented in a multi-dish switch between the STB and the satellite LNBs. Furthermore, the present invention may include an RF loop bypass that passes the incoming signal directly.

While the invention has been particularly shown and described with reference to the preferred embodiments thereof, it will be understood by those skilled in the art that various changes in form and details may be made without departing from the spirit and scope of the invention. For example, while the present invention has been described in connection with a satellite system, the present invention may easily be implemented in other architectures and applications such as cable and terrestrial STBs.

1. An apparatus comprising:
a set-top box configured to generate output signals in response to a first encoded data signal;
a conversion circuit configured to present said first encoded data signal in response to a second encoded data signal received from an external source, wherein said first encoded data signal comprises a legacy signal and said second encoded data signal comprises an advanced data signal.

2. The apparatus according to claim 1, wherein said external source comprises a low noise block (LNB) of a satellite dish or other antenna.

3. The apparatus according to claim 1, wherein said external source comprises an over the air (OTA) antenna.

4. The apparatus according to claim 1, wherein said external source comprises a cable television signal.

5. The apparatus according to claim 1, wherein said advanced data signal comprises an 8PSK, 16QAM or similar digitally modulated compliant signal.

6. The apparatus according to claim 1, wherein said advanced signal comprises a Turbo, LDPC (low density parity check) or other similar coded signal.

7. The apparatus according to claim 1, wherein said advanced signal comprises a signal in accordance with a second standard developed after a first standard of said legacy signal.

8. The apparatus according to claim 1, wherein said conversion circuit passes said second encoded data signal.

9. The apparatus according to claim 1, wherein said advanced signal is not backwards compatible to said legacy signal.

10. An apparatus for translating signals presented to a set-top box comprising:
means for generating output signals in response to a first encoded data signal;
means for presenting said first encoded data signal in response to a second encoded data signal received from an external source, wherein said first encoded data signal comprises a legacy signal and said second encoded data signal comprises an advanced data signal.

11. A method for translating signals presented to a set-top box comprising the steps of:
(A) generating output signals in response to a first encoded data signal; and
(B) presenting said first encoded data signal in response to a second encoded data signal received from an external source, wherein said first encoded data signal comprises a legacy signal and said second encoded data signal comprises an advanced data signal.

12. The apparatus according to claim 1, further comprising a communication interface operating between said set-top box and said conversion circuit, where said interface communicates using one or more VBI signals.

13. The apparatus according to claim 1, further comprising a communication interface operating between said set-top box and said conversion circuit, where said interface communicates using one or more null packets.

14. The apparatus according to claim 1, further comprising a communication interface operating between said set-top box and said conversion circuit, where said interface communicates using MPEG signal elements that do not contain information of the program to be watched.

15. The apparatus according to claim 13, wherein said interface communicates using IF sampling through a single digital to analog converter to generate harmonics in the frequency range of said set top box.

16. The apparatus according to claim 1, wherein said first encoded data signal comprises an MPEG2 signal and said second signal comprises an MPEG4 signal.

17. The apparatus according to claim 1, wherein said first encoded data signal comprises an MPEG signal and said second encoded data signal comprises a digital data signal.

18. The apparatus according to claim 1, wherein said conversion circuit is implemented as a single integrated circuit.
